(19) United States
(12) Patent Application Publication
(10) Pub. No.: US 2026/0074929 A1
(43) Pub. Date: Mar. 12, 2026

(54) DYNAMIC COMMUNICATION SCHEME SWITCHING

(71) Applicant: QUALCOMM Incorporated, San Diego, CA (US)

(72) Inventors: Tom BARAK, Rehovot (IL); Michael LEVITSKY, Rehovot (IL); Elad MEIR, Ramat Gan (IL); Daniel PAZ, Atlit (IL); Oren MATSRAFI, Yad Modechai (IL)

(21) Appl. No.: 18/830,487

(22) Filed: Sep. 10, 2024

(51) Int. Cl. H04L 1/00; H04B 7/0413; H04L 5/00

(52) U.S. Cl. CPC H04L 25/03; H04L 25/03949; H04B 7/0413; H04L 1/0001; H04L 5/0055

(57) ABSTRACT

A device may one or more memories, individually or in combination, having instructions. A device may one or more processors, individually or in combination, configured to execute the instructions and cause the apparatus to: receive a sampled reference signal; and transmit an indication of a communication scheme selected from a plurality of communication schemes based at least in part on the sampled reference signal.

### BACKGROUND

### Technical Field

The present disclosure generally relates to communication systems, and more particularly, to communications between an extended reality (XR) device and a companion device (e.g., wireless node).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

Aspects of the disclosure are directed to an apparatus for wireless communication. In some examples, the apparatus includes one or more memories, individually or in combination, having instructions, and one or more processors, individually or in combination, configured to execute the instructions. In some examples, the one or more processors are configured to receive a sampled reference signal. In some examples, the one or more processors are configured to transmit an indication of a communication scheme selected from a plurality of communication schemes based at least in part on the sampled reference signal.

Aspects of the disclosure are directed to an apparatus for wireless communication. In some examples, the apparatus includes one or more memories, individually or in combination, having instructions, and one or more processors, individually or in combination, configured to execute the instructions. In some examples, the one or more processors are configured to transmit a sampled reference signal. In some examples, the one or more processors are configured to receive an indication of a communication scheme selected from a plurality of communication schemes based at least in part on the sampled reference signal.

Aspects of the disclosure are directed to a method for wireless communication at an apparatus. In some examples, the method includes receiving a sampled reference signal. In some examples, the method includes transmitting an indication of a communication scheme selected from a plurality of communication schemes based at least in part on the sampled reference signal.

Aspects of the disclosure are directed to a method for wireless communication at an apparatus. In some examples, the method includes transmitting a sampled reference signal. In some examples, the method includes receiving an indication of a communication scheme selected from a plurality of communication schemes based at least in part on the sampled reference signal.

Aspects of the disclosure are directed to an apparatus configured for wireless communication. In some examples, the apparatus includes means for receiving a sampled reference signal. In some examples, the apparatus includes means for transmitting an indication of a communication scheme selected from a plurality of communication schemes based at least in part on the sampled reference signal.

Aspects of the disclosure are directed to an apparatus configured for wireless communication. In some examples, the apparatus includes means for transmitting a sampled reference signal. In some examples, the apparatus includes means for receiving an indication of a communication scheme selected from a plurality of communication schemes based at least in part on the sampled reference signal.

Aspects of the disclosure are directed to a non-transitory computer-readable medium comprising instructions that, when executed by an apparatus, cause the apparatus to perform a method. In some examples, the method includes receiving a sampled reference signal. In some examples, the method includes transmitting an indication of a communication scheme selected from a plurality of communication schemes based at least in part on the sampled reference signal.

Aspects of the disclosure are directed to a non-transitory computer-readable medium comprising instructions that, when executed by an apparatus, cause the apparatus to perform a method. In some examples, the method includes transmitting a sampled reference signal. In some examples, the method includes receiving an indication of a communication scheme selected from a plurality of communication schemes based at least in part on the sampled reference signal.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture.

FIG. 5 is a block diagram illustrating an example pre-equalization process for a minimum mean squared error (MMSE) multiple-input multiple-output (MIMO) communication scheme.

FIG. 6 is a block diagram illustrating an example pre-equalization process for a Tomlinson-Harashima Precoding (THP) MMSE pre-equalization scheme for a 2×2 MIMO system.

FIG. 7 is a call-flow diagram illustrating example processes and communications between an extended reality (XR) device and a UE.

FIG. 8 is a block diagram illustrating example steps of a process performed at a UE.

FIG. 9 is a flowchart of a method of wireless communication.

FIG. 10 is a diagram illustrating an example of a hardware implementation for an example apparatus.

FIG. 11 is a flowchart of a method of wireless communication.

FIG. 12 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Extended reality (XR), which includes virtual reality (VR), augmented reality (AR), and mixed reality (MR), is poised to revolutionize various sectors such as entertainment, education, and healthcare. Despite its potential, XR faces significant hurdles before it can achieve widespread commercialization and market penetration akin to that of smartphones, smartwatches, or earbuds. The primary challenges that need to be addressed include lightweight design, processing and power consumption, and power efficiency of XR devices.

For XR devices to be comfortable for long-term use and mobility they need to be lightweight. Current XR devices are often bulky and heavy, which limits their usability and comfort. Achieving a lightweight design may require advancements in materials science, miniaturization of components, and the development of lightweight batteries. Moreover, the heat dissipation capabilities of XR devices are limited, restricting processing complexity and power consumption to just a few watts. Such design requirements and limitations make support for complex XR applications that require significant computational resources a challenge. Balancing performance with power consumption is critical, as high-performance XR applications, such as real-time rendering and complex simulations, demand substantial processing power, which may be difficult to achieve within the power constraints of lightweight, wearable devices.

To support lightweight batteries, power consumption at XR devices may need to be reduced to provide a reasonable battery life. Users may expect their devices to last for several hours on a single charge, which is currently a significant challenge for XR devices. To address these challenges, aspects of the disclosure are directed to offloading of processing tasks from the XR device to its companion User Equipment (UE) or a combination of UE and gNB. The goal is to transform the XR device into a primarily input/output (I/O) device that only transmits local sensor information to the UE without any pre-processing. This distribution aims to optimize performance and power consumption while minimizing latency and providing a seamless user experience.

In some examples, the proposed approach aims to shift complex processing aspects of the XR device's receiver (Rx) to the UE, gNB, or other companion device. This approach may be applied across all functional components of the XR device, including the physical layer (PHY) and modem-related complexity. Most of the modem complexity is typically associated with Rx-side processing. There are several complexity reduction approaches for different PHY Rx components that allow for achieving low complexity, low power, and low latency in sidelink XR device communications.

Aspects of the disclosure are directed to a 2×2 multiple-input multiple-output (MIMO) scheme with a transmit (Tx) equalization-based waveform and two spatial layer transmission (e.g., using Tx minimum mean square error (MMSE) or Tomlinson-Harashima Precoding (THP) based schemes) over sidelink for the downlink direction. Such a MIMO scheme with two layers may achieve higher throughput relative to single-layer schemes such as single-input single-output (SISO) or multiple-input single-output (MISO).

However, a MIMO scheme with two layers coupled with Tx equalization may be more sensitive to adverse channel conditions and characteristics compared to a single-layer transmission alternative. Additionally, in a MIMO scenario, the XR device may be required to process multiple Rx antennas all the time, instead of a single antenna processing for SISO or MISO alternatives. For many scenarios, a Tx equalization-based single-layer transmission using a MISO scheme, which relies on dynamic Tx/Rx antenna selection, can provide better performance and lower XR device-side complexity.

Accordingly, for different scenarios, a companion device (e.g., UE) may select from different communication schemes (e.g., MIMO or MISO) and select from different Tx equalization variants (THP, MMSE, or matched filter (MF)) for communications between the UE and the XR device to reduce Rx processing at the XR device and achieve better link performance with constrained Tx power and constrained XR device complexity. In some examples, the UE may select from the different communication schemes and equalization variants based on channel conditions, different performance metrics associated with each of the communication schemes and equalization variants, and the UE may transmit signaling to the XR device indicating which communication scheme to use.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

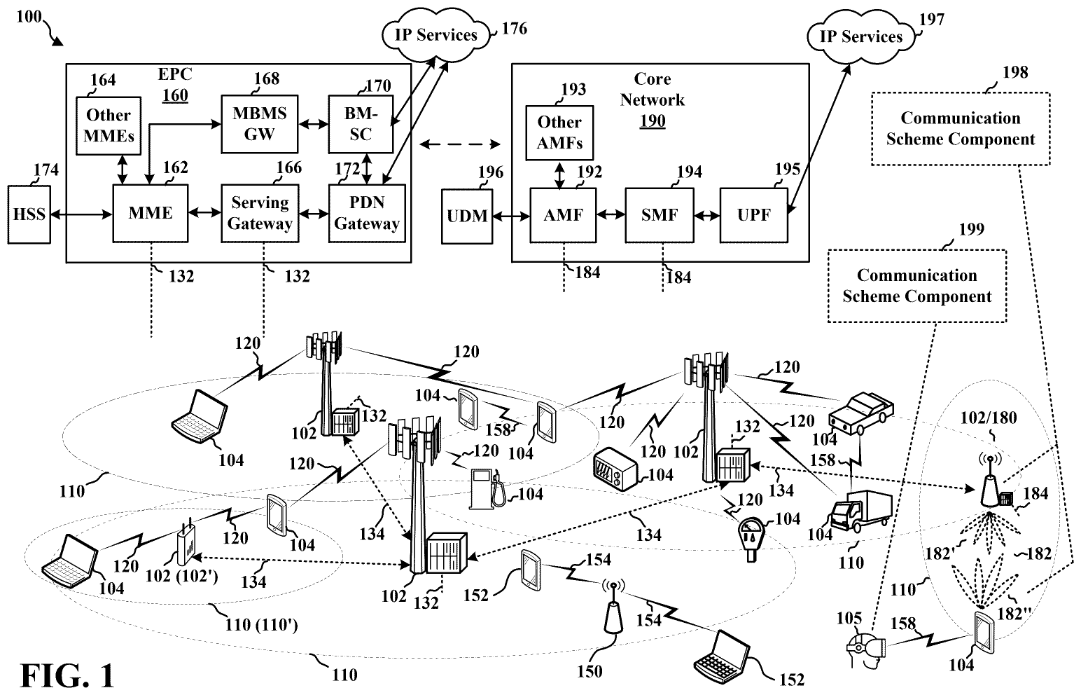

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (cNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other and other wireless nodes (e.g., extended reality (XR) device 105) using a device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming. The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless node may comprise a UE, a base station, or a network entity.

Referring again to FIG. 1, the UE 104 and or base station 102 may include a communication scheme component 198. As described in more detail elsewhere herein, the communication scheme component 198 may be configured to receive a sampled reference signal; and transmit an indication of a communication scheme selected from a plurality of communication schemes based at least in part on the sampled reference signal. Additionally, or alternatively, the communication scheme component 198 may perform one or more other operations described herein.

The XR device 105 may also include a communication scheme component 199. As described in more detail elsewhere herein, the communication scheme component 199 may be configured to transmit a sampled reference signal; and receive an indication of a communication scheme selected from a plurality of communication schemes based at least in part on the sampled reference signal. Additionally, or alternatively, the communication scheme component 199 may perform one or more other operations described herein.

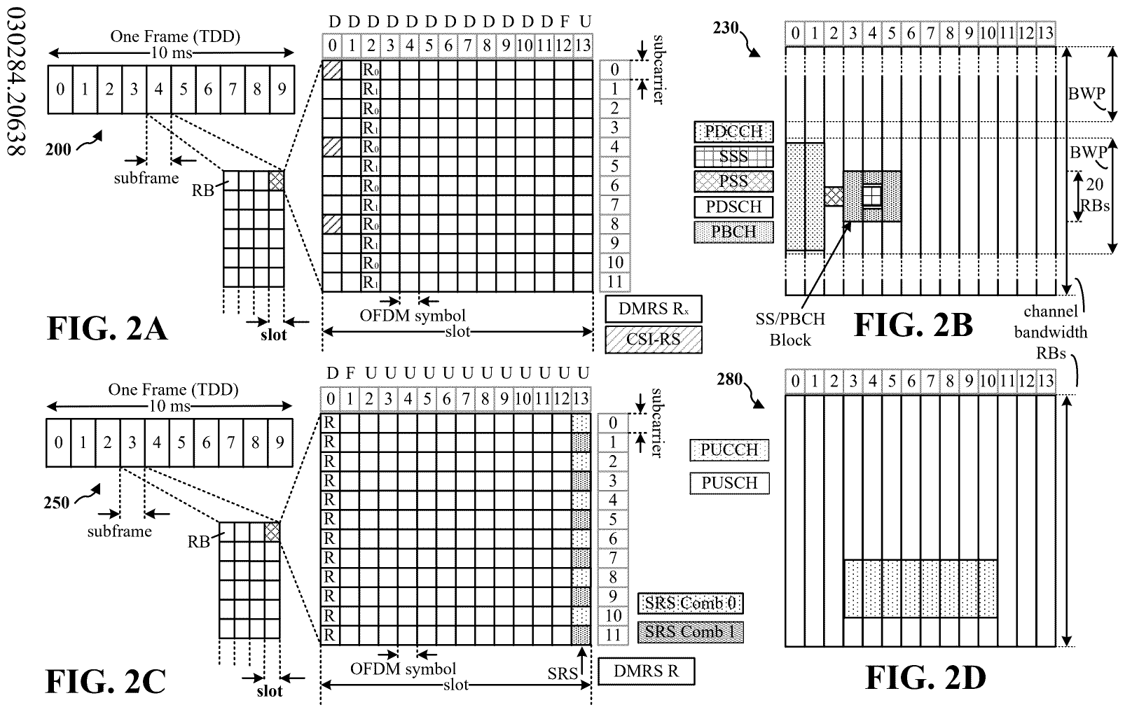

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

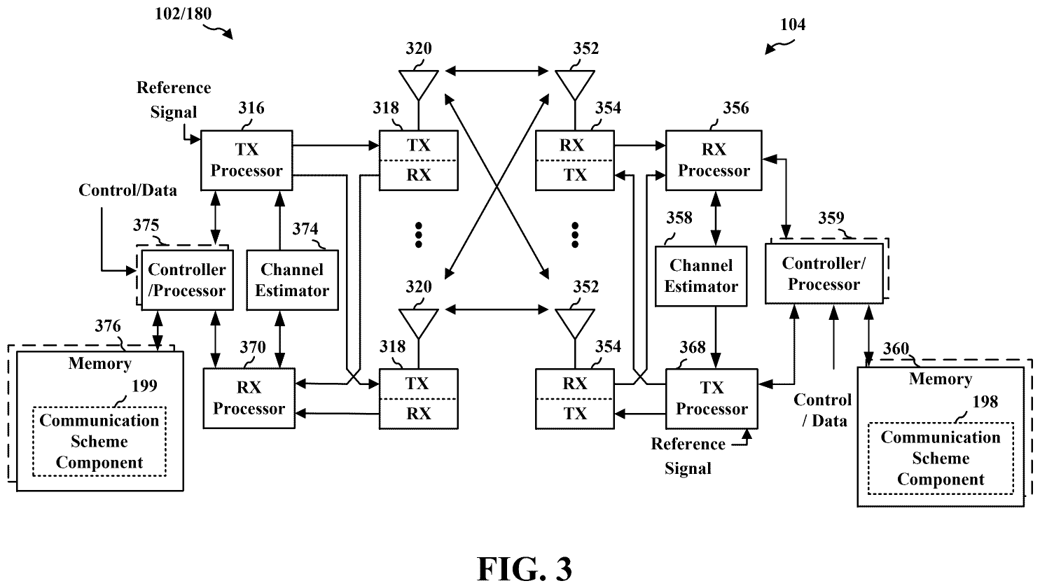

FIG. 3 is a block diagram of a base station 102/180 in communication with a UE 104 in an access network. In the DL, IP packets from the EPC 160 may be provided to one or more controller/processors 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102/180, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 198 of FIG. 1.

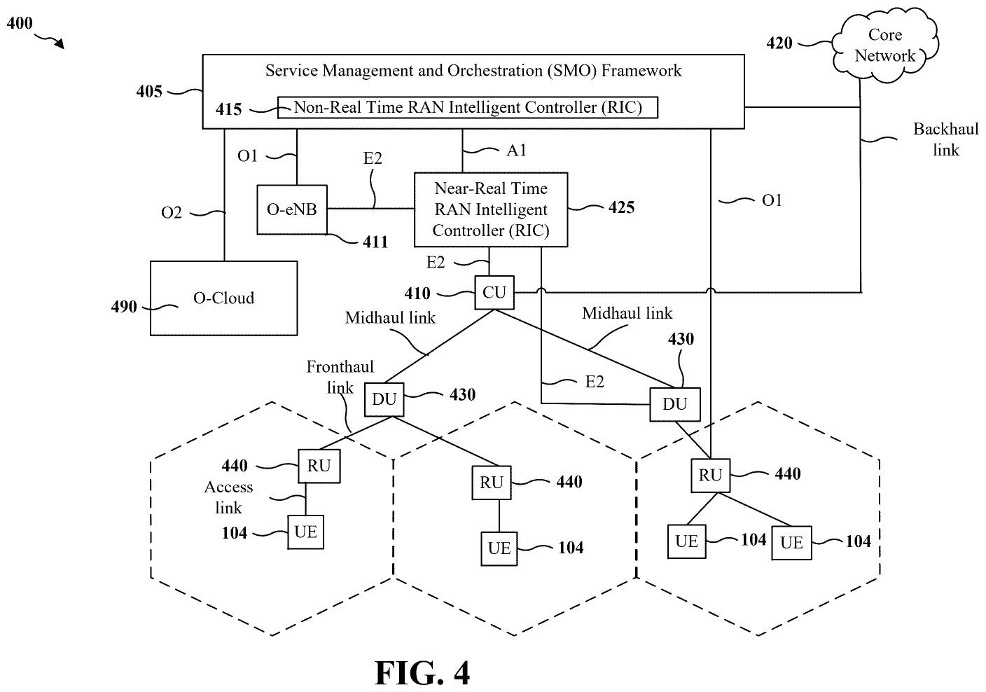

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440. As used herein, a network entity may correspond to a base station or to a disaggregated aspect (e.g., CU/DU/RU, etc.) of the base station.

Each of the units, i.e., the CUs 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include one or more receivers, one or more transmitters or transceivers (such as one or more radio frequency (RF) transceivers), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit-user plane (CU-UP)), control plane functionality (i.e., central unit-control plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open cNB (O-eNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405. The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an A1 interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via O1) or via creation of RAN management policies (such as A1 policies).

### Examples of Single-Layer Transmission Options and Communication Scheme Evaluation

As discussed, aspects of the disclosure are directed to shifting aspects of XR device processing to a companion device (e.g., UE, gNB, or another companion device). In the context of equalization performed at the UE, single-layer transmission may provide higher performance communications between the UE and XR device in some scenarios relative to equalization performed at the XR device. For example, a two-layer MIMO scheme may be more sensitive to adverse channel conditions relative to a single layer transmission alternative. Additionally, for the MIMO scenario, the XR device is required to process multiple antennas instead of a single antenna processing for SISO or MISO alternatives.

Single-layer transmission may be implemented using MIMO, MISO, or SISO communication schemes. For a 2×2 MIMO with a single layer, complementary antennas may be combining at the XR device. Such combining may be performed coherently using proper complex coefficients associated with different weighting used for receiver-side (e.g., XR device) antennas per RE. However, aspects of the disclosure are directed to reducing or eliminating the processing at the XR device to support such a scheme, such as channel estimation by the XR device.

Thus, in certain aspects, 2×2 MIMO communications with a single layer may be supported by assuming or pre-evaluating scalar combining weights for the XR device by the UE. Such assumptions or scalar combining weights may be configured to maximize XR device SNR on average across a relevant bandwidth. The scalar coefficients may be evaluated and calculated on the Tx-side (e.g., by the UE), based on channel knowledge and estimated noise variance (e.g., noise covariance matrix) of the XR device, and then transmitted to the XR device via a control channel. The coefficients may be calculated as wideband coefficients (e.g., applicable to an entire D2D band) or on a per sub-band basis (e.g., multiple coefficients, each mapped to a corresponding subband). Accordingly, the coefficients may be used for XR device combining that is aligned with equalization assumptions at the UE. It should be noted that in some examples, a 2×2 MIMO scheme may involve more power consumption at the XR device for processing multiple Rx antennas during communication with the UE.

In certain aspects, a MISO scheme, with UE matched filter ((MF), aka maximum ratio transmission (MRT)) or beamforming via two UE Tx antennas targeting a single Rx antenna without equalization or filtering/combining at the XR device, may outperform MIMO in some scenarios. In some examples, a MISO scheme implementation may utilize dynamic and adaptive single Rx antenna selection, whereby the UE may select a single antenna at the XR device based on channel estimation and other communication parameters (e.g., Rx antenna imbalance due to NLOS or body-related blockage or antenna pattern variance at the XR device).

In another example, single-layer transmission may be based on a SISO communication scheme with pre-equalization performed at the UE. Here, the UE may perform dynamic selection of both a single Tx antenna at the UE and a single Rx antenna at the XR device.

Thus, based on the above, a UE may dynamically perform a communication scheme evaluation and switch from a current communication scheme to another communication scheme based on UE-side (e.g., Tx-side) measurements. For example, the UE may evaluate multiple communication schemes (e.g., MIMO with two layers using Tx MMSE/THP or MISO with a single layer using Tx MF and Rx antenna selection) based on channel conditions and other communication parameters (e.g., channel estimation and noise covariance matrix).

In scenarios without channel reciprocity, the UE may transmit a reference signal (e.g., DMRS, or other suitable reference signal) to the XR device. The XR device may be configured to sample and compress the received reference signal, then transmit an indication of the compressed reference signal to the UE. Here, the communication scheme evaluation may be performed using the compressed reference signal. In one example, the UE may estimate a 2×2 MIMO channel and noise covariance matrix for receiving a downlink signal by the XR device based on the compressed samples received from the XR device periodically (e.g., once per CSI refresh period, or as per system configuration). The CSI refresh period can range from 1 millisecond (ms) or one or more slots up to a few tens of slots/ms. In some examples, the CSI refresh period may be dynamically adapted by the UE to channel mobility characteristics. In some examples, the UE may dynamically perform a communication scheme evaluation for each communication scheme on a periodic, semi-persistent, or event-driven basis.

In some examples, the UE may dynamically perform a communication scheme evaluation based on a spectral efficiency (SE) metric associated with each scheme, whereby the UE estimates a channel matrix, a noise covariance matrix associated with the XR device (e.g., based on the sampled reference signal) and a corresponding Tx equalization per communication scheme. In some examples, the communication scheme evaluation may be based on additional channel, receiver, and/or end-to-end (E2E) system characteristics/parameters. This selection can be evaluated once per CSI refresh period, once per a longer time window, or on an event-driven basis (e.g., an increase in NACK rate).

In some examples, the UE may select a communication scheme and one or more other communication parameters associated with the scheme. Here, the UE may further select a modulation and coding scheme (MCS) based on one or more metrics used for the communication scheme evaluation to determine an MCS index for an optimal operational SNR.

In some examples, the UE may determine to switch from a current communication scheme to another scheme if a threshold condition is satisfied. In some examples, the threshold condition may be satisfied by one or more factors, including operational SNR, channel condition number or type (e.g., channel condition such as path loss, multipath propagation, Doppler shift, shadowing, etc.), channel mobility/time correlation (e.g., channel condition changes due to movement at one point in time relative to another point in time), CSI refresh period, delays in receiving the sampled reference signal from the XR device, XR device antenna imbalance, etc.

In some examples, the UE may estimate an SNR metric per Rx antenna for the XR device during communication scheme evaluation. The SNR metric may represent either an input SNR or post-processing SNR (ppSNR) including a corresponding Tx for each Rx antenna. That is, for example, if the UE performs a communication scheme evaluation and determines to switch from a current MIMO communication scheme to a MISO or SISO communication scheme, the UE may also evaluate which Rx antenna at the XR device to use for transmitting downlink signaling. The UE may transmit an indication of the selected Rx antenna, along with an indication of the MISO/SISO scheme selection, via a downlink control channel to the XR device. In some examples, the UE may perform an evaluation to select an Rx antenna per channel band. That is, the UE may determine an Rx antenna for wideband (WB) communication or an Rx antenna per sub-band used for communications between the UE and XR device.

In some examples, the UE may use machine learning based processing to perform evaluation of all the communication parameters for communication scheme evaluation and/or Rx antenna selection.

Accordingly, the UE may dynamically evaluate and, if necessary, switch communication scheme and/or Rx antenna to provide an optimal communication scheme based on real-time channel conditions and system parameters.

### Examples of Signaling for Communication Scheme and/or Rx Antenna Change

As previously mentioned, although a MIMO communication scheme with MMSE-based equalization and two spatial layers may provide a higher throughput in certain scenarios, MISO schemes (e.g., 2 Tx antennas and 1 Rx antenna) with equalization based on matched filtering and single-layer transmission may provide improved communication performance up to a certain SNR threshold compared to MIMO. Because the SNR may depend on channel and system characteristics, the UE may perform communication scheme evaluations and switch between different communication schemes adaptively based on different factors associated with communication and channel characteristics.

One such factor is channel aging (e.g., where the quality and characteristics of a wireless channel changes over time due to user mobility, environmental changes, changes in the network, etc.). In some examples, a MIMO scheme may be more sensitive to channel aging relative to a MISO or SISO scheme. Relatively high Doppler velocity or a long CSI refresh period may result in poor inter-layer interference mitigation in a MIMO MMSE scheme. Another factor relates to channel type and characteristics. A communication channel with multiple multipath components may result in very frequency-selective channels, which may present challenges for UE-side equalization. This may result in antenna imbalance between the UE and the XR device which may degrade MIMO equalization performance.

The impact of the aforementioned channel characteristics may be estimated by the UE using a spectral efficiency metric that can be evaluated for each candidate communication scheme hypothesis based on the estimated channel and estimated noise at the XR device.

The receiving side (e.g., the XR device) may be made aware of the communication scheme selected by the UE via downlink signaling. In one example, the UE may provide the XR device with an indication of which Rx antenna(s) the XR device may use for receiving downlink signaling from the UE. This is because, in the case of MIMO, each Rx antenna corresponds to one spatial layer. In the case of MISO or SISO, the UE may configure the XR device via an indication of which Rx antenna the XR device can expect to receive signaling. Moreover, the UE may provide the XR device with an indication of which equalization scheme the UE will use for its transmission. For example, in MIMO, equalization schemes may include Tomlinson-Harashima Precoding (THP) and minimum mean square error (MMSE). Each of THP and MMSE may require a different process for establishing pre-equalization.

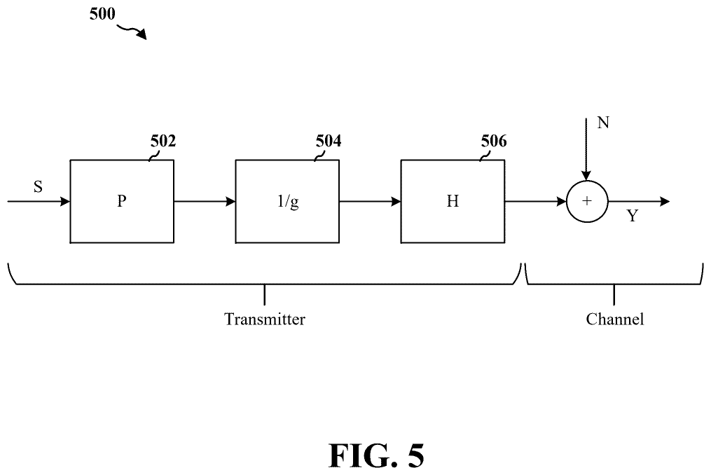

FIG. 5 is a block diagram illustrating an example pre-equalization process 500 for a MMSE MIMO communication scheme. This and other pre-equalization processes described herein may be used to optimize the transmission, via the UE, of signals via MMSE MIMO.

A signal(S) to be transmitted by the UE may be processed using a pre-equalization matrix (P). The pre-equalization matrix may be configured as a channel-dependent matrix and designed to minimize an error between the transmitted signal and an estimation of the signal as received by the XR device(S). The optimization problem may be formulated as follows in Equation 1:

$$\{ {P}_{MMSE} , {g}_{MMSE} \} = {arg min 𝔼}_{P , g} [ {‖ \underline{S} - \hat{\underline{S}} ‖}^{2} ] subject to : \\ \{ 𝔼 [ {‖ \frac{1}{g} P \underline{S} ‖}^{2} ] = tr \{ 𝔼 ( \frac{1}{{g}^{2}} P \underline{S} \cdot {( P \underline{S} )}^{H} ) \} = {P}_{T} \} \qquad Equation 1$$

where P_{T} is the total transmit power.

The MMSE pre-equalization matrix (P_{MMSE}) may be derived as follows in Equation 2:

$${P}_{MMSE} = \frac{1}{{g}_{MMSE}} {{H}^{H} ( {HH}^{H} + ε I )}^{- 1} , where ε = \frac{1}{SNR} = \frac{tr \{ {R}_{nn} \}}{{P}_{T}} ; and {R}_{S} = 𝔼 [ {SS}^{H} ] = I \qquad Equation 2$$

A scaling factor (g_{MMSE}) may be used to ensure that a transmit power constraint is met. It may be derived as follows in Equation 3:

$${g}_{MMSE} = \sqrt{\frac{t r \{ {{H}^{H} ( {HH}^{H} + ε I )}^{- 2} H \}}{{P}_{T}}} \qquad Equation 3$$

Here, the transmitted signal(S) is passed through the pre-equalization matrix (P) at a first block 502, resulting in a pre-equalized signal (PS). At a second block 504, the pre-equalized signal may be scaled by a factor

$$( \frac{1}{g} )$$

to ensure that the total transmit power constraint is satisfied. At a third block 506, the scaled, pre-equalized signal is passed through a channel matrix (H). The signal received (Y) is the result of the pre-equalized and scaled signal passing through the channel matrix and being affected by noise (N).

The MMSE pre-equalization scheme may be configured to minimize error between the signal as transmitted and the signal as received while adhering to a transmit power constraint. By using the MMSE pre-equalization matrix (P_{MMSE}) and the scaling factor (g_{MMSE}), the UE can optimize signal transmission to the XR device for given channel conditions. This approach may be particularly useful in MIMO systems, where managing inter-layer interference and maintaining signal quality are critical for achieving high throughput and reliable communication. This and other pre-equalization processes described herein may be used to optimize the transmission, via the UE, of signals via MMSE MIMO.

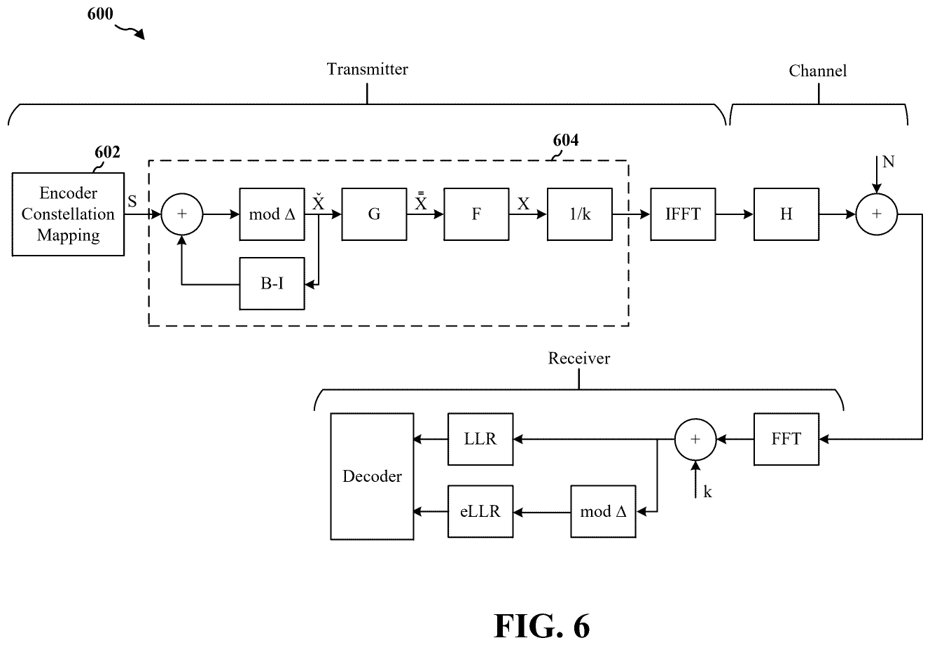

FIG. 6 is a block diagram illustrating an example pre-equalization process for a THP MMSE pre-equalization scheme 600 for a 2×2 MIMO OFDM end-to-end system. This scheme is designed to account for noise enhancement on the XR device side (e.g., receiver side) by relaxing the complete interference removal requirement, thereby performing better than Zero-Forcing (ZF) THP. THP MIMO pre-equalization may be performed as follows:

$$\begin{matrix}LQ = H + {ε ( H ↑ )}^{H} + H , \\ where G = diag ( {\{ L \}}_{i i}^{- 1} ) , \\ B = LG , and \\ F = {Q}^{H}\end{matrix} \qquad Equation 4$$

where H is the channel matrix, ¿ is a regularization parameter associated with the SNR, L is a lower triangular matrix, and Q is an orthogonal matrix. Further, G is a diagonal matrix where each diagonal element is the inverse of the corresponding diagonal element of L, B is a matrix used in the precoding process, and F is the Hermitian transpose of the orthogonal matrix (Q).

A power scaling factor

$$( \frac{1}{{k}^{2}} )$$

may be defined as follows:

$$\frac{1}{{k}^{2}} = \frac{{P}_{T}}{tr \{ 𝔼 ( x \cdot {x}^{H} ) \}} \qquad Equation 5$$

where P_{T} is the total transmit power, and x is the transmitted signal vector.

Depending on the dimensions of the channel matrix (H), inversion may be handled differently. For example, if H can be defined as an M_{Rx}×N_{Tx} matrix, then:

$$\begin{matrix}H ↑ = {{H}^{H} ( {HH}^{H} )}^{- 1} , where M \leq N \\ H ↑ = {H}^{H - 1} , where M = N \\ H ↑ = {( {H}^{H} H )}^{- 1} {H}^{H} , where M \geq N\end{matrix} \qquad Equation 6$$

In some examples, a regularization parameter (E) may be defined as follows, where Rₙₙ is the noise covariance matrix:

$$ε = \frac{1}{SNR} = \frac{tr \{ {R}_{nn} \}}{{P}_{T}} \qquad Equation 7$$

Thus, FIG. 6 illustrates an example process of THP pre-equalization of a 2×2 MIMO communication at a transmitter (e.g., UE), and transmission of the equalized signal to a receiver (e.g., XR device). At a first block 602, source data may be input to be encoded and mapped to a QPSK constellation, and an encoded signal for transmission(S) is output. The encoded signal may then be processed sequentially via a second block 604 which applies the THP MMSE pre-equalization, using the functions described above. The scaled signal (X) may then be transmitted through the MIMO channel (H). At the receiver, received signal (Y) is processed through an FFT (Fast Fourier Transform) and linear Tx filter. An enhanced LLR (eLLR) calculation is performed to mitigate non-linear effects, and an LLR is scaled based on the post-processing noise variance.

As such, the THP MMSE pre-equalization scheme 600 is designed to optimize the transmission of signals in a 2×2 MIMO OFDM system by accounting for noise enhancement on the Rx side. By relaxing the complete interference removal requirement, the THP MMSE scheme performs better than ZF THP, particularly in scenarios with high noise levels. The detailed formulation and diagram illustrate the process of pre-equalization, power scaling, and signal processing, ensuring robust and efficient communication in MIMO systems.

For MISO communication scheme, the UE may transmit an indication of the specific Rx antenna port that the XR device (e.g., receiving-side) may use to receive signaling from the UE. For example, the UE may transmit in indication of an index of the Rx antenna that the UE selected as the active or targeted Rx antenna. This selection may be performed by the UE, as described above.

Accordingly, the UE may transmit a dynamic communication scheme indication to the XR device via a downlink control channel. In some examples, the indication may be provided as a single bit. For example, ‘0’ may indicate MIMO based on Tx MMSE/THP, and ‘1’ may indicate MISO based on Tx MF, according to the selected communication scheme that maximizes spectral efficiency. In some examples, an additional bit can be used with dual usage: indicating the MMSE or the THP equalization type for MIMO (if the first bit is ‘0’) or the Rx antenna port/index for MISO (if the first bit is ‘1’). A corresponding example is shown below in Table 1.

TABLE 1

| Selected Communication Scheme | MSB | LSB |
|---|---|---|
| MIMO Tx MMSE | 0 | 0 |
| MIMO THP MMSE | 0 | 1 |
| MISO (Tx MF), Rx Ant1 | 1 | 0 |
| MISO (Tx MF), Rx Ant2 | 1 | 1 |

In Table 1, for MIMO with Tx MMSE, the MSB is ‘0’ and the LSB is ‘0.’ For MIMO with THP MMSE, the MSB is ‘0’ and the LSB is ‘1.’ For MISO (Tx MF) with Rx Antenna 1, the MSB is ‘1’ and the LSB is ‘0.’ For MISO (Tx MF) with Rx Antenna 2, the MSB is ‘1’ and the LSB is ‘1.’

This signaling mechanism ensures that the XR device is correctly informed about the communication scheme selected by the UE and can adjust its processing accordingly. This dynamic indication allows for optimal performance by selecting the appropriate transmission scheme based on real-time channel conditions and system parameters.

Ultimately, the Tx scheme is selected as the one that maximizes the SE metric. All mathematical expressions and formulas for MIMO SE evaluation are provided on slide 14. This adaptive approach ensures that the optimal transmission scheme is chosen based on real-time channel conditions and system parameters, thereby maximizing performance and efficiency. By dynamically selecting between MIMO and MISO schemes, the system can maintain high throughput and reduce complexity at the XR device, in varying and challenging channel environments.

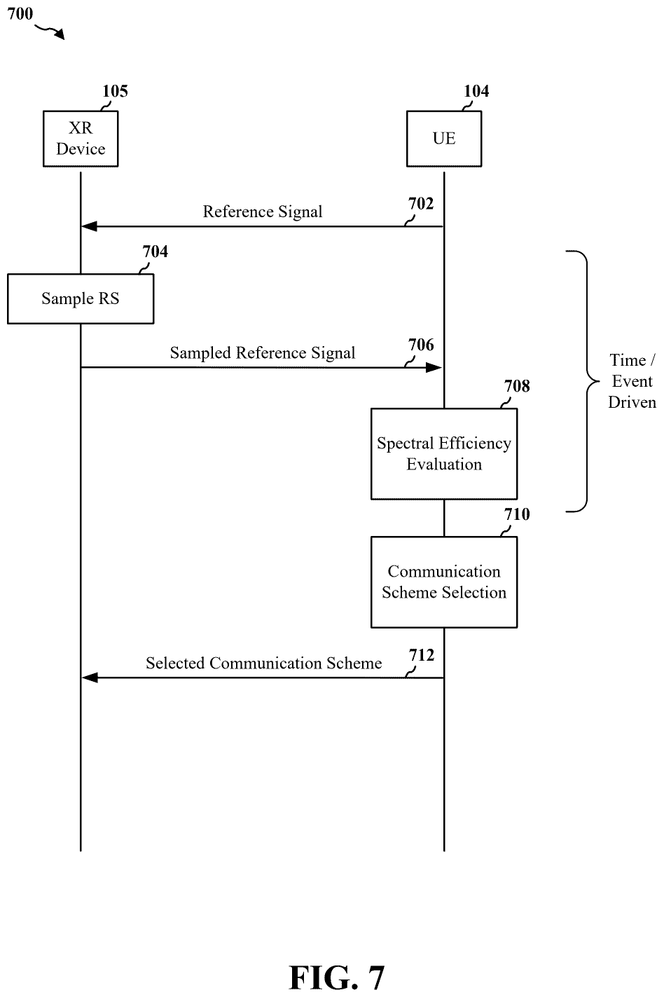

FIG. 7 is a call-flow diagram illustrating example processes and communications 700 between an XR device (e.g., XR device 105 of FIG. 1) and a UE (e.g., UE 104 of FIG. 1).

At a first communication 702, the UE 104 may transmit a reference signal (e.g., a DMRS or any other suitable reference signal) via a D2D communication link (e.g., D2D communication link 158 of FIG. 1). The XR device 105 may receive the reference signal and, at a first process 704, the XR device 105 may sample the received reference signal and compress the sample. Then, at a second communication 706, the XR device 105 may transmit an indication of the sampled refence signal to the UE 104 via the D2D link. The UE 104, at a second process 708, may perform a spectral efficiency evaluation based on the sampled reference signal.

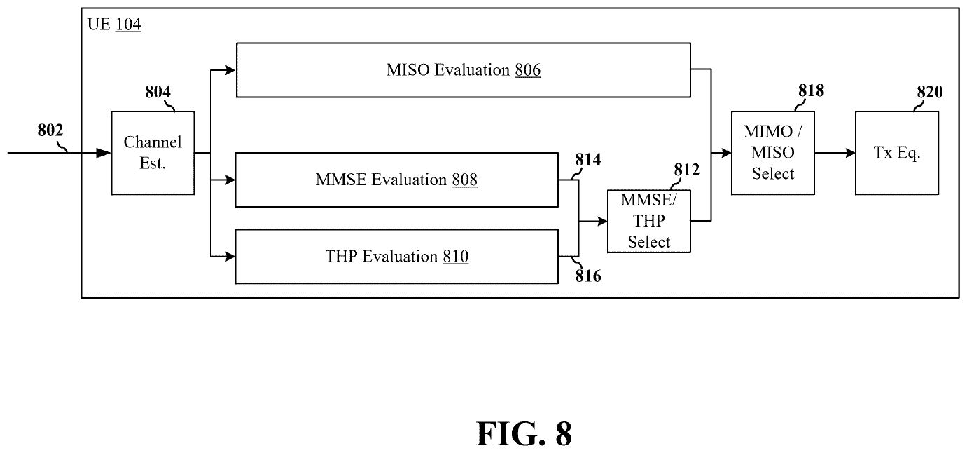

Initially, the UE 104 may perform channel estimation of the D2D link based on the sampled reference signal 802, whereby the UE 104 may estimate both the channel (e.g., calculate a channel matrix per RE) and channel noise (e.g., calculate a noise covariance matrix) associated with the D2D link. Referring now to FIG. 8, the UE may receive the sampled reference signal 802 and estimate the channel at a first block 804. Here, the UE 104 may estimate H and Run as described above. The UE 104 may then perform a MISO evaluation at a second block 806, a MIMO MMSE evaluation at a third block 808, and a MISO THP evaluation at a fourth block 810 to estimate spectral efficiency for each communication scheme.

In some examples, the MIMO spectral efficiency may be evaluated as follows:

$${H}_{k} = [ \begin{matrix}{h}_{11 k} & {h}_{12 k} \\ {h}_{21 k} & {h}_{22 h}\end{matrix} ] ∈ {ℂ}^{2 x 2} \qquad Equation 8$$

where Hₖ is the channel matrix per the kth RE,

$${σ}_{{n}_{i}}^{2}$$

is the estimated noise variance per Rx antenna, and SF is the evaluated Tx power scaling. Indices i∈{0,1} and j∈{0,1} represent the Rx antennas (corresponding to the spatial layer index) and Tx antennas, respectively.

For UWB, there may be an effective isotropic radiated power (EIRP) restriction defined per 1 MHz. Thus, a Tx equalization evaluation may be performed per 1 MHz, based on this constraint. The scaling factor (SF) may also be defined based on this constraint (e.g., per 1 MHz). Therefore, in this examples, there are M different scaling values per 1 MHz sub-band, where m∈{0, . . . , M−1} is the scaling value index. For instance, each SFₘ may be constant per 8 REs, assuming an SCS of 125 kHz. Accordingly, the spectral efficiency for MIMO may be estimated as follows, where the received signal (yₖ) is given by:

$${\underline{y}}_{k} = \frac{1}{{SF}_{m}} {H}_{k} {P}_{k} {\underline{s}}_{k} \qquad Equation 9$$

$$where$$

$${SF}_{m} = \sqrt{{\sum }_{k ∈ 1 MH {z}_{m}} tr \{ {P}_{k}^{H} {P}_{k} \}} \qquad Equation 10$$

and where the diagonal unbiasing matrix per RE is denoted by:

$${W}_{k} {=}^{Δ} [ \begin{matrix}\frac{1}{{\{ {H}_{k} {P}_{k} \}}_{11}} & 0 \\ 0 & \frac{1}{{\{ {H}_{k} {P}_{k} \}}_{22}}\end{matrix} ] \qquad Equation 11$$

A source data vector (sₖ) is transmitted from the UE per RE, yₖ represents the received data after passing through the channel per RE, and Pₖ ∈ [symbol] ^{2×2} represents the pre-equalization matrix per RE. The spectral efficiency for MIMO (SE_{MIMO}) is evaluated as:

$${SE}_{MIMO} = {\sum }_{i = 0}^{1} [ \frac{1}{{N}_{RE}} {\sum }_{k = 0}^{{N}_{RE} - 1} {log}_{2} ( 1 + \frac{1}{{[ ( {W}_{k} {H}_{k} {P}_{k} - I ) {( {W}_{k} {H}_{k} {P}_{k} - I )}^{H} ]}_{ii}} + {SF}_{m}^{2} {σ}_{{n}_{i}}^{2} {\vert {W}_{{k}_{ii}} \vert}^{2} ) ] - {b}_{SE} \qquad Equation 12$$

Here, Wₖ ∈ [symbol] ^{2×2} represents a diagonal unbiasing matrix per RE, and the biasing term b_{SE} may depend on various parameters such as channel time correlation, CSI refresh period, CSI delivery delay, and additional inputs not related to channel aging (e.g., antenna imbalance ratio, condition number (CN), delay spread (DS), antenna correlation), as described above. In some examples, these factors may increase the sensitivity of MIMO relative to MISO. The expressions for MIMO MMSE and MIMO THP equalization matrices are discussed above.

As discussed, the efficient usage of a MISO communication scheme may include selecting the targeted/active Rx antenna that is assumed by an equalization match filtering procedure performed at the UE. Accordingly, the antenna selection may be performed by the UE, based on the estimated H and Rₙₙ. The selection can be based on the corresponding average post-processing SNR (ppSNR), spectral efficiency, and/or even input SNR. The SNR for the ith Rx antenna may be calculated as follows:

$${SNR}_{i}^{( dB )} = \frac{1}{{N}_{RE}} {\sum }_{k = 0}^{{N}_{RE} - 1} 10 {log}_{10} ( \frac{{\sum }_{j = 1}^{2} {\vert {H}_{{ij}_{k}} \vert}^{2}}{{σ}_{{n}_{i}}^{2}} ) \qquad Equation 13$$

The optimal Rx antenna (i*) may then be selected as follows:

$${i}^{*} = arg {max}_{i} \{ {SNR}_{i} \} \qquad Equation 14$$

With the selected Rx antenna, the corresponding MISO spectral efficiency metric may be evaluated as follows, where sₖ represents a source data (scalar) per RE, yₖ is the received data after passing through the UWB channel per RE, and pₖ ∈ [symbol] ^{2×1} is the Tx equalization vector per RE. The received signal yₖ is given by:

$${\underline{y}}_{k} = \frac{1}{{SF}_{m}} {H}_{k} {\underline{p}}_{k} {s}_{k} + {\underline{n}}_{k} \qquad Equation 15$$

$$where$$

$${h}_{{i}_{k}^{*}} = [ {h}_{{1}_{k}} , {h}_{{2}_{k}} ] \qquad Equation 16$$

$$and$$

$${p}_{k} = \frac{{{h}_{{i}^{*}}}_{k}^{H}}{{‖ {h}_{{i}^{*}} ‖}^{2}} \qquad Equation 17$$

The Tx scaling factor (SFₘ) is defined as:

$${SF}_{m} = \sqrt{{\sum }_{k ∈ 1 {MHz}_{m}} {‖ {\underline{p}}_{k} ‖}^{2}} \qquad Equation 18$$

The SE for the MISO scheme is then evaluated as:

$${SE}_{MISO} = \frac{1}{{N}_{RE}} {\sum }_{k = 0}^{{N}_{RE} - 1} {log}_{2} ( 1 + \frac{{‖ {H}_{k} {\underline{p}}_{k} ‖}^{2}}{{σ}_{{n}_{{i}^{*}}}^{2} {SF}_{m}^{2}} ) \qquad Equation 19$$

If the MISO scheme is selected over MIMO, the selected Rx antenna port/index is signaled from the UE to the XR device to indicate which Rx antenna to use for equalized data reception. This signaling is done via the downlink (DL) control channel using an additional control bit, as discussed above.

At a fifth block 812, the UE 104 may select either MIMO MMSE or MIMO THP based on the pre-equalization metric for MIMO MMSE 814 and the pre-equalization metric for MIMO THP 816.

At a sixth block 818 (illustrated as third process 710 in FIG. 7), the UE may select, based on the evaluation at the second block 806 and the selection at the fifth block 812, as well as the associated pre-equalization metrics, whether to continue to use the current communication scheme, or switch to a MISO or a MIMO communication scheme. If a MISO scheme is selected, the UE may also select which XR device antenna to transmit to, based on which antenna is estimated to have better spectral efficiency. For this selection, the UE may also base the selection on a biasing associated with the MIMO scheme. For example, communications via MIMO schemes may suffer from factors such as channel time correlation (e.g., in a rapidly changing environment, the channel state information may become outdated quickly, which may negatively affect MIMO performance), CSI refresh period and/or CSI delivery delay (e.g., MIMO relies timely CSI to optimize its beamforming, power control, and/or scheduling performance. Refresh periods and delivery delays may result in outdated information, reduced throughput, increased error rate, and/or impaired beamforming), antenna imbalance ratio (e.g., imperfect balance between antenna elements may result in reduced signaling capacity and/or increased interference between the antenna elements), etc. At seventh block 820, the UE 104 may determine a transmission equalization for the selected MIMO or MISO communication scheme. The UE

Referring back to FIG. 7, at a third communication 712, the UE may transmit an indication of the selected communication scheme to the XR device 105.

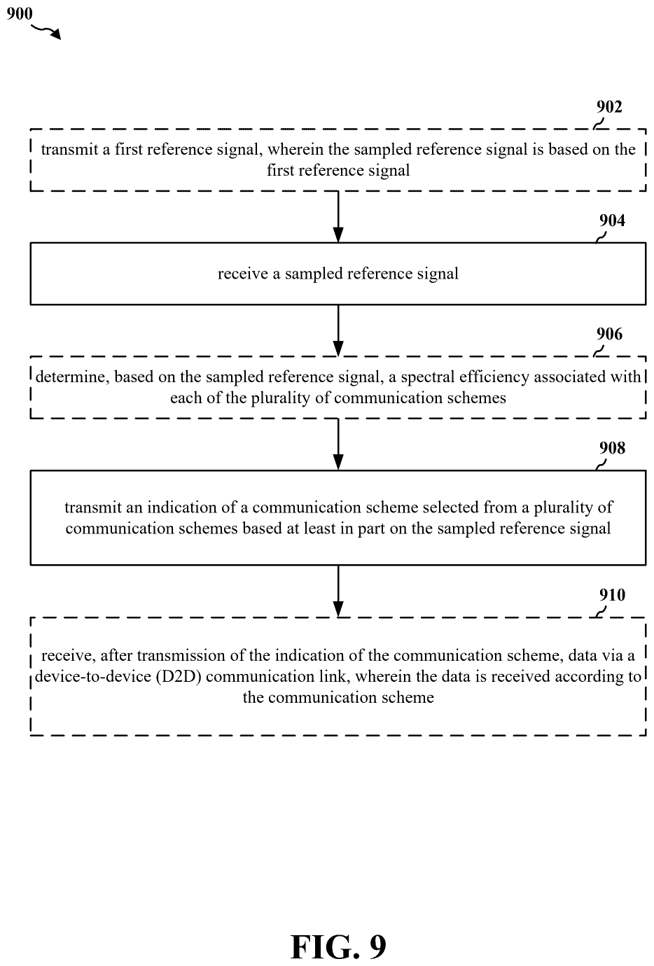

FIG. 9 is a flowchart 900 of a method of wireless communication. The method may be performed by a UE (e.g., the UE 104; the apparatus 1002) or a network entity. For example, the method may be performed by one or more memories, processors, and RF front ends (e.g., the memory 360, controller/processor 359, transmitter 354TX, receiver 354RX, antenna 352, etc. of FIG. 3), or the method may be performed by one or more memories, processors, and RF front ends (e.g., the memory 376, controller/processor 375, transmitter 318TX, receiver 318RX, antenna 320, etc. of FIG. 3).

At 902, the UE may optionally transmit a first reference signal, wherein the sampled reference signal is based on the first reference signal. For example, 902 may be performed by a transmitting component 1040.

At 904, the UE may receive a sampled reference signal. For example, 904 may be performed by a receiving component 1042.

At 906, the UE may optionally determine, based on the sampled reference signal, a spectral efficiency associated with each of the plurality of communication schemes. For example, 906 may be performed by a determining component 1044.

At 908, the UE may transmit an indication of a communication scheme selected from a plurality of communication schemes based at least in part on the sampled reference signal. For example, 908 may be performed by the transmitting component 1040.

Finally, at 910, the UE may optionally receive, after transmission of the indication of the communication scheme, data via a device-to-device (D2D) communication link, wherein the data is received according to the communication scheme. For example, 910 may be performed by the receiving component 1042.

In certain aspects, the plurality of communication schemes includes one or more of: a multiple-input multiple output (MIMO) scheme, a multiple-output single-input (MISO) scheme, or a single-input single-output (SISO) scheme.

In certain aspects, the communication scheme is a MIMO scheme, and wherein the indication of the communication scheme further comprises an indication of a transmit equalization precoder associated with the MIMO scheme.

In certain aspects, the transmit equalization precoder comprises one of a Tomlinson-Harashima Precoding (THP) or a minimum mean square error (MMSE) precoding.

In certain aspects, the communication scheme is a MISO scheme, and wherein the indication of the communication scheme further comprises an indication of an antenna port associated with a wireless node from which the sampled reference signal was received.

In certain aspects, the spectral efficiency is determined on a periodic, semi-persistent, or event-driven basis.

In certain aspects, the spectral efficiency is based on a channel estimate and a noise estimate associated with one or more antenna of a wireless node from which the sampled reference signal was received.

In certain aspects, the indication of the communication scheme comprises an indication of a modulation and coding scheme associated with the communication scheme.

In certain aspects, the sampled reference signal is received, and the indication of the communication scheme is transmitted, via a device-to-device (D2D) communication link.

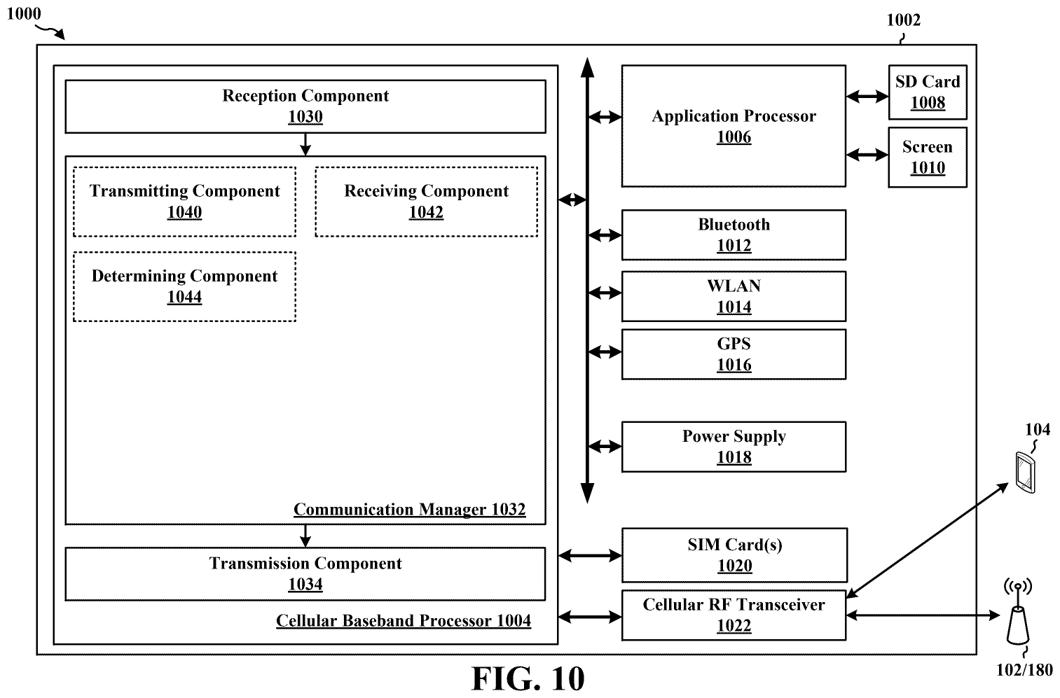

FIG. 10 is a diagram 1000 illustrating an example of a hardware implementation for an apparatus 1002. The apparatus 1002 may be implemented as a UE or a network entity, and includes a cellular baseband processor 1004 (also referred to as a modem) coupled to one or more cellular RF transceivers 1022 and one or more subscriber identity modules (SIM) cards 1020, an application processor 1006 coupled to a secure digital (SD) card 1008 and a screen 1010, a Bluetooth module 1012, a wireless local area network (WLAN) module 1014, a Global Positioning System (GPS) module 1016, and a power supply 1018. The cellular baseband processor 1004 communicates through the one or more cellular RF transceivers 1022 with the UE 104 and/or BS 102/180. The cellular baseband processor 1004 may include a computer-readable medium/memory. The computer-readable medium/memory may be non-transitory. The cellular baseband processor 1004 is responsible for general processing, including the execution of software stored on the computer-readable medium/memory. The software, when executed by the cellular baseband processor 1004, causes the cellular baseband processor 1004 to perform the various functions described supra. The computer-readable medium/memory may also be used for storing data that is manipulated by the cellular baseband processor 1004 when executing software. The cellular baseband processor 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the cellular baseband processor 1004. The cellular baseband processor 1004 may be a component of the UE 104 and may include the memory 360 and/or at least one of the TX processor 368, the RX processor 356, and the controller/processor 359. In one configuration, the apparatus 1002 may be a modem chip and include just the baseband processor 1004, and in another configuration, the apparatus 1002 may be the entire UE (e.g., see UE 104 of FIG. 3) and include the aforediscussed additional modules of the apparatus 1002. In various examples, the apparatus 1002 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1032 includes a transmitting component 1040 that is configured to transmit a first reference signal, wherein the sampled reference signal is based on the first reference signal; and transmit an indication of a communication scheme selected from a plurality of communication schemes based at least in part on the sampled reference signal, e.g., as described in connection with 902 and 908.

The communication manager 1032 further includes a receiving component 1042 configured to: receive a sampled reference signal; and receive, after transmission of the indication of the communication scheme, data via a device-to-device (D2D) communication link, wherein the data is received according to the communication scheme, e.g., as described in connection with 904 and 910.

The communication manager 1032 further includes a determining component 1044 configured to determine, based on the sampled reference signal, a spectral efficiency associated with each of the plurality of communication schemes, e.g., as described in connection with 906.

The apparatus may include additional components that perform each of the blocks of the algorithm in the aforementioned flowcharts of FIG. 9. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1002, and in particular the cellular baseband processor 1004, includes: means for transmitting a first reference signal, wherein the sampled reference signal is based on the first reference signal; means for receiving a sampled reference signal; means for determining, based on the sampled reference signal, a spectral efficiency associated with each of the plurality of communication schemes; means for transmitting an indication of a communication scheme selected from a plurality of communication schemes based at least in part on the sampled reference signal; and means for receiving, after transmission of the indication of the communication scheme, data via a device-to-device (D2D) communication link, wherein the data is received according to the communication scheme.

The aforementioned means may be one or more of the aforementioned components of the apparatus 1002 configured to perform the functions recited by the aforementioned means. As described supra, the apparatus 1002 may include the TX processor 368, the RX processor 356, and the controller/processor 359. As such, in one configuration, the aforementioned means may be the TX processor 368, the RX processor 356, and the controller/processor 359 configured to perform the functions recited by the aforementioned means.

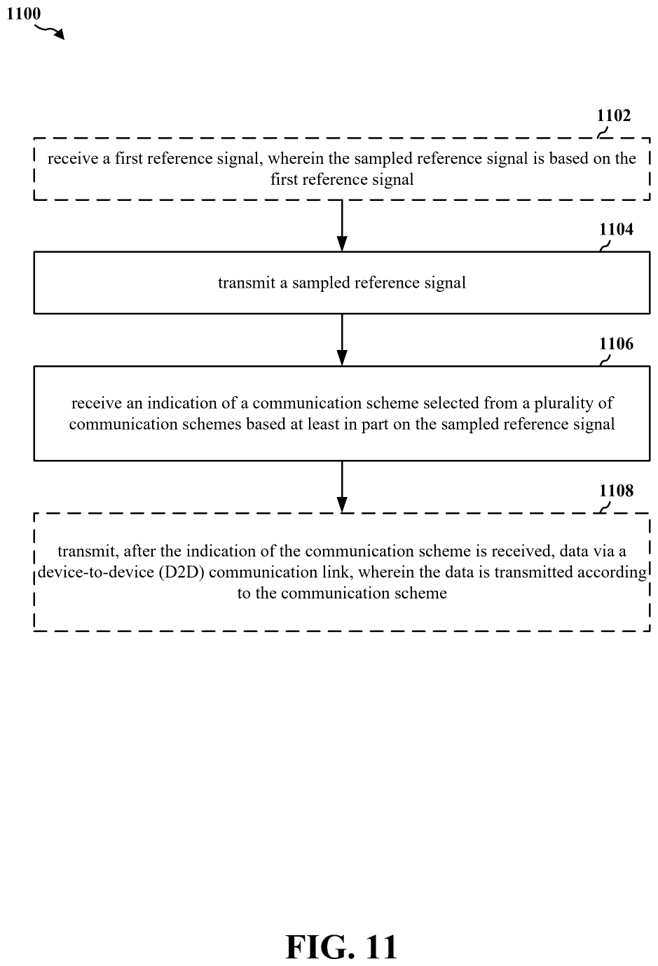

FIG. 11 is a flowchart 1100 of a method of wireless communication. The method may be performed by an XR device (e.g., the XR device 105; the apparatus 1202).

At 1102, the UE may optionally receive a first reference signal, wherein the sampled reference signal is based on the first reference signal. For example, 1102 may be performed by a receiving component 1240.

At 1104, the UE may transmit a sampled reference signal. For example, 1104 may be performed by a transmitting component 1042.

At 1106, the UE may receive an indication of a communication scheme selected from a plurality of communication schemes based at least in part on the sampled reference signal. For example, 1106 may be performed by the receiving component 1040.

At 908, the UE may optionally transmit, after the indication of the communication scheme is received, data via a device-to-device (D2D) communication link, wherein the data is transmitted according to the communication scheme. For example, 908 may be performed by the transmitting component 1042.

In certain aspects, the plurality of communication schemes includes one or more of: a multiple-input multiple output (MIMO) scheme, a multiple-output single-input (MISO) scheme, or a single-input single-output (SISO) scheme.

In certain aspects, the communication scheme is a MIMO scheme, and wherein the indication of the communication scheme further comprises an indication of a transmit equalization precoder associated with the MIMO scheme.

In certain aspects, the transmit equalization precoder comprises one of a Tomlinson-Harashima Precoding (THP) or a minimum mean square error (MMSE) precoding.

In certain aspects, the communication scheme is a MISO scheme, and wherein the indication of the communication scheme further comprises an indication of an antenna port associated with the apparatus.

In certain aspects, the indication of the communication scheme comprises an indication of a modulation and coding scheme associated with the communication scheme.

In certain aspects, the sampled reference signal is transmitted, and the indication of the communication scheme is received, via a device-to-device (D2D) communication link.

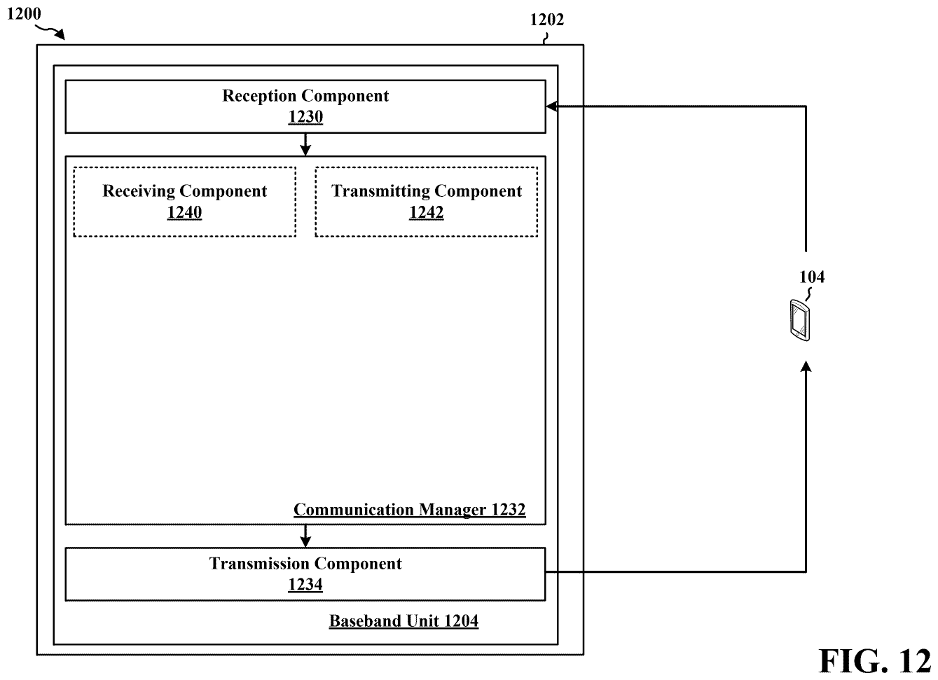

FIG. 12 is a diagram 1200 illustrating an example of a hardware implementation for an apparatus 1202. The apparatus 1202 is an XR device and includes a baseband unit 1204. The baseband unit 1204 may communicate through one or more cellular RF transceivers with the UE 104. The baseband unit 1204 may include a computer-readable medium/memory. The baseband unit 1204 is responsible for general processing, including the execution of software stored on the computer-readable medium/memory. The software, when executed by the baseband unit 1204, causes the baseband unit 1204 to perform the various functions described supra. The computer-readable medium/memory may also be used for storing data that is manipulated by the baseband unit 1204 when executing software. The baseband unit 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the baseband unit 1204. The baseband unit 1204 may be a component of the XR device and may include the memory 376 and/or at least one of the TX processor 316, the RX processor 370, and the controller/processor 375. In various examples, the apparatus 1202 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1232 includes a receiving component 1240 configured to: receive a first reference signal, wherein the sampled reference signal is based on the first reference signal; and receive an indication of a communication scheme selected from a plurality of communication schemes based at least in part on the sampled reference signal, e.g., as described in connection with 1102 and 1106.

The communication manager 1232 further includes a transmitting component 1242 configured to: transmit a sampled reference signal; and transmit, after the indication of the communication scheme is received, data via a device-to-device (D2D) communication link, wherein the data is transmitted according to the communication scheme, e.g., as described in connection with 1104 and 1108.

The apparatus may include additional components that perform each of the blocks of the algorithm in the aforementioned flowchart of FIG. 11. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1202, and in particular the baseband unit 1204, includes: means for receiving a first reference signal, wherein the sampled reference signal is based on the first reference signal; means for transmitting a sampled reference signal; means for receiving an indication of a communication scheme selected from a plurality of communication schemes based at least in part on the sampled reference signal; and means for transmitting, after the indication of the communication scheme is received, data via a device-to-device (D2D) communication link, wherein the data is transmitted according to the communication scheme. The aforementioned means may be one or more of the aforementioned components of the apparatus 1202 configured to perform the functions recited by the aforementioned means.

### Additional Considerations

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### EXAMPLE ASPECTS

The following examples are illustrative only and may be combined with aspects of other embodiments or teachings described herein, without limitation.

Example 1 is a method for wireless communication at an apparatus, comprising: receiving a sampled reference signal; and transmitting an indication of a communication scheme selected from a plurality of communication schemes based at least in part on the sampled reference signal.

Example 2 is the method of Example 1, further comprising: transmitting a first reference signal, wherein the sampled reference signal is based on the first reference signal.

Example 3 is the method of any of Examples 1 and 2, wherein the plurality of communication schemes includes one or more of: a multiple-input multiple output (MIMO) scheme, a multiple-output single-input (MISO) scheme, or a single-input single-output (SISO) scheme.

Example 4 is the method of Example 3, wherein the communication scheme is a MIMO scheme, and wherein the indication of the communication scheme further comprises an indication of a transmit equalization precoder associated with the MIMO scheme.

Example 5 is the method of Example 4, wherein the transmit equalization precoder comprises one of a Tomlinson-Harashima Precoding (THP) or a minimum mean square error (MMSE) precoding.

Example 6 is the method of Example 3, wherein the communication scheme is a MISO scheme, and wherein the indication of the communication scheme further comprises an indication of an antenna port associated with a wireless node from which the sampled reference signal was received.

Example 7 is the method of any of Examples 1-6, further comprising: determining, based on the sampled reference signal, a spectral efficiency associated with each of the plurality of communication schemes.

Example 8 is the method of Example 7, wherein the spectral efficiency is determined on a periodic, semi-persistent, or event-driven basis.

Example 9 is the method of Example 7, wherein the spectral efficiency is based on a channel estimate and a noise estimate associated with one or more antenna of a wireless node from which the sampled reference signal was received.

Example 10 is the method of any of Examples 1-9, wherein the indication of the communication scheme comprises an indication of a modulation and coding scheme associated with the communication scheme.

Example 11 is the method of any of Examples 1-10, wherein the sampled reference signal is received, and the indication of the communication scheme is transmitted, via a device-to-device (D2D) communication link.

Example 12 is the method of any of Examples 1-11, further comprising: receiving, after transmission of the indication of the communication scheme, data via a device-to-device (D2D) communication link, wherein the data is received according to the communication scheme.

Example 13 is the method of any of Examples 1-12, wherein the apparatus is configured as a user equipment (UE) or a network entity.

Example 14 is a method for wireless communication at an apparatus, comprising: transmitting a sampled reference signal; and receiving an indication of a communication scheme selected from a plurality of communication schemes based at least in part on the sampled reference signal.

Example 15 is the method of Example 14, further comprising: receiving a first reference signal, wherein the sampled reference signal is based on the first reference signal.

Example 16 is the method of any of Examples 14 and 15, wherein the plurality of communication schemes includes one or more of: a multiple-input multiple output (MIMO) scheme, a multiple-output single-input (MISO) scheme, or a single-input single-output (SISO) scheme.

Example 17 is the method of Example 16, wherein the communication scheme is a MIMO scheme, and wherein the indication of the communication scheme further comprises an indication of a transmit equalization precoder associated with the MIMO scheme.

Example 18 is the method of Example 17, wherein the transmit equalization precoder comprises one of a Tomlinson-Harashima Precoding (THP) or a minimum mean square error (MMSE) precoding.

Example 19 is the method of Example 16, wherein the communication scheme is a MISO scheme, and wherein the indication of the communication scheme further comprises an indication of an antenna port associated with the apparatus.

Example 20 is the method of any of Examples 14-19, wherein the indication of the communication scheme comprises an indication of a modulation and coding scheme associated with the communication scheme.

Example 21 is the method of any of Examples 14-20, wherein the sampled reference signal is transmitted, and the indication of the communication scheme is received, via a device-to-device (D2D) communication link.

Example 22 is the method of any of Examples 14-21, further comprising: transmitting, after the indication of the communication scheme is received, data via a device-to-device (D2D) communication link, wherein the data is transmitted according to the communication scheme.

Example 23 is the method of any of Examples 14-22, wherein the apparatus is configured as an extended reality (XR) device.

Example 2^{μ} is an apparatus for wireless communications, comprising means for performing a method in accordance with any one of Examples 1-13.

Example 25 is an apparatus for wireless communications, comprising means for performing a method in accordance with any one of Examples 14-23.

Example 26 is a non-transitory computer-readable medium comprising instructions that, when executed by a wireless node, cause the wireless node to perform a method in accordance with any one of Examples 1-13.

Example 27 is a non-transitory computer-readable medium comprising instructions that, when executed by a wireless node, cause the wireless node to perform a method in accordance with any one of Examples 14-23.

Example 28 is an apparatus for wireless communications, comprising: one or more memories, individually or in combination, having instructions; and one or more processors, individually or in combination, configured to execute the instructions and cause the apparatus to perform a method in accordance with any one of Examples 1-13.

Example 29 is an apparatus for wireless communications, comprising: one or more memories, individually or in combination, having instructions; and one or more processors, individually or in combination, configured to execute the instructions and cause the apparatus to perform a method in accordance with any one of Examples 14-23.

What is claimed is:

1. An apparatus for wireless communication, comprising:
one or more memories, individually or in combination, having instructions; and
one or more processors, individually or in combination, configured to execute the instructions and cause the apparatus to:
receive a sampled reference signal; and
transmit an indication of a communication scheme selected from a plurality of communication schemes based at least in part on the sampled reference signal.

2. The apparatus of claim 1, wherein the one or more processors, individually or in combination, are further configured to:
transmit a first reference signal, wherein the sampled reference signal is based on the first reference signal.

3. The apparatus of claim 1, wherein the plurality of communication schemes includes one or more of: a multiple-input multiple output (MIMO) scheme, a multiple-output single-input (MISO) scheme, or a single-input single-output (SISO) scheme.

4. The apparatus of claim 3, wherein the communication scheme is a MIMO scheme, and wherein the indication of the communication scheme further comprises an indication of a transmit equalization precoder associated with the MIMO scheme.

5. The apparatus of claim 4, wherein the transmit equalization precoder comprises one of a Tomlinson-Harashima Precoding (THP) or a minimum mean square error (MMSE) precoding.

6. The apparatus of claim 3, wherein the communication scheme is a MISO scheme, and wherein the indication of the communication scheme further comprises an indication of an antenna port associated with a wireless node from which the sampled reference signal was received.

7. The apparatus of claim 1, wherein the one or more processors, individually or in combination, are further configured to:
determine, based on the sampled reference signal, a spectral efficiency associated with each of the plurality of communication schemes.

8. The apparatus of claim 7, wherein the spectral efficiency is determined on a periodic, semi-persistent, or event-driven basis.

9. The apparatus of claim 7, wherein the spectral efficiency is based on a channel estimate and a noise estimate associated with one or more antenna of a wireless node from which the sampled reference signal was received.

10. The apparatus of claim 1, wherein the indication of the communication scheme comprises an indication of a modulation and coding scheme associated with the communication scheme.

11. The apparatus of claim 1, wherein the sampled reference signal is received, and the indication of the communication scheme is transmitted, via a device-to-device (D2D) communication link.

12. The apparatus of claim 1, wherein the one or more processors, individually or in combination, are further configured to:
receive, after transmission of the indication of the communication scheme, data via a device-to-device (D2D) communication link, wherein the data is received according to the communication scheme.

13. The apparatus of claim 1, wherein the apparatus is configured as a user equipment (UE) or a network entity.

14. An apparatus for wireless communication, comprising:
one or more memories, individually or in combination, having instructions; and
one or more processors, individually or in combination, configured to execute the instructions and cause the apparatus to:
transmit a sampled reference signal; and
receive an indication of a communication scheme selected from a plurality of communication schemes based at least in part on the sampled reference signal.

15. The apparatus of claim 14, wherein the one or more processors, individually or in combination, are further configured to:
receive a first reference signal, wherein the sampled reference signal is based on the first reference signal.

16. The apparatus of claim 14, wherein the plurality of communication schemes includes one or more of: a multiple-input multiple output (MIMO) scheme, a multiple-output single-input (MISO) scheme, or a single-input single-output (SISO) scheme.

17. The apparatus of claim 16, wherein the communication scheme is a MIMO scheme, and wherein the indication of the communication scheme further comprises an indication of a transmit equalization precoder associated with the MIMO scheme.

18. The apparatus of claim 17, wherein the transmit equalization precoder comprises one of a Tomlinson-Harashima Precoding (THP) or a minimum mean square error (MMSE) precoding.

19. The apparatus of claim 16, wherein the communication scheme is a MISO scheme, and wherein the indication of the communication scheme further comprises an indication of an antenna port associated with the apparatus.

20. A method for wireless communication at an apparatus, comprising:
receiving a sampled reference signal; and
transmitting an indication of a communication scheme selected from a plurality of communication schemes based at least in part on the sampled reference signal.
